(19) United States
(12) Patent Application Publication
(10) Pub. No.: US 2024/0412081 A1
(43) Pub. Date: Dec. 12, 2024

(54) INFORMATION PROCESSING DEVICE, INFORMATION PROCESSING METHOD, AND NON-TRANSITORY STORAGE MEDIUM

(71) Applicant: NEC Corporation, Minato-ku, Tokyo (JP)

(72) Inventor: Yuzuru Okajima, Tokyo (JP)

(73) Assignee: NEC Corporation, Minato-ku, Tokyo (JP)

(21) Appl. No.: 18/699,697

(22) PCT Filed: Oct. 29, 2021
(86) PCT No.: PCT/JP2021/039967

§ 371 Date: Apr. 9, 2024

(51) Int. Cl. G06N 5/022

(52) U.S. Cl. CPC G06N 5/022

(57) ABSTRACT

In order to achieve an object to make it possible to more accurately detect an abnormal instance, an information processing apparatus includes: an acquisition means (21) that acquires an instance expressed as a set of a plurality of features; a prediction means (22) that outputs a plurality of prediction results which are obtained by using (i) as a target variable, at least one of the plurality of features which are included in the instance and (ii) as explanatory variables, a plurality of subsets of features obtained by excluding the at least one feature from the plurality of features, the subsets being different from each other; and an abnormality degree output means (23) that outputs a degree of abnormality of the instance, with reference to the plurality of prediction results.

### TECHNICAL FIELD

The present invention relates to an information processing apparatus, an information processing method, and a program which make it possible to more accurately detect an abnormal instance.

### BACKGROUND ART

According to a conventionally known technique, a feature included in an instance is predicted with use of a prediction model that has been trained in advance with reference to a plurality of instances, and an instance whose value of the feature thus predicted significantly deviates from a true value, which is a value of the feature included in the instance, is detected as an abnormal instance.

For example, Patent Literature 1 discloses learning, as an instance, data including D features, and training prediction models which are obtained with use of each one of features as a target variable and remaining D−1 features as explanatory variables.

In Patent Literature 1, D features of an instance which is subject to determination as to whether or not the instance is abnormal are predicted with use of respective D trained prediction models. Then, for example, whether or not the instance is abnormal is determined by comparing, with a threshold, an averaged difference between respective predicted values and true values.

Further, also proposed is a technique according to which: a plurality of prediction models different from each other are used when one feature is predicted; and degrees of deviation indicating how much respective predicted values obtained with use of the prediction models deviate from a true value is calculated (see, for example, Non-Patent Literature 1).

According to Non-Patent Literature 1, whether or not the instance is abnormal is determined by comparing, with a threshold, the sum of the degrees of deviation of the respective prediction values obtained with use of the prediction models.

### CITATION LIST

### Patent Literature

### [Patent Literature 1]

US Patent Application Publication No. 2005/0283511

### Non-Patent Literature

### [Non-Patent Literature 1]

K. Noto et. al., “FRaC: A feature-modeling approach for semi-supervised and unsupervised anomaly detection”, 2012

### SUMMARY OF INVENTION

### Technical Problem

However, there may be a case where in an instance, a feature becomes an abnormal value and many other features may accordingly become abnormal values. In such a case, the feature can be predicted from those other features. Then, in this case, the instance then cannot be determined to be an abnormal instance. In neither Patent Literature 1 nor Non-Patent Literature 2, this point was not taken into consideration.

An example aspect of the present invention is attained in view of the above problem. An example object of the present invention is to provide a technique that makes it possible to more accurately detect an abnormal instance.

### Solution to Problem

An information processing apparatus according to an aspect of the present invention includes: an acquisition means that acquires an instance expressed as a set of a plurality of features; a prediction means that outputs a plurality of prediction results which are obtained by using (i) as a target variable, at least one of the plurality of features which are included in the instance and (ii) as explanatory variables, a plurality of subsets of features obtained by excluding the at least one feature from the plurality of features, the subsets being different from each other; and an abnormality degree output means that outputs a degree of abnormality of the instance, with reference to the plurality of prediction results.

An information processing method according to an aspect of the present invention includes: acquiring an instance expressed as a set of a plurality of features; outputting a plurality of prediction results which are obtained by using (i) as a target variable, at least one of the plurality of features which are included in the instance and (ii) as explanatory variables, a plurality of subsets of features obtained by excluding the at least one feature from the plurality of features, the subsets being different from each other; and outputting a degree of abnormality of the instance, with reference to the plurality of prediction results.

A program according to an aspect of the present invention causes a computer to function as an information processing apparatus that includes: an acquisition means that acquires an instance expressed as a set of a plurality of features; a prediction means that outputs a plurality of prediction results which are obtained by using (i) as a target variable, at least one of the plurality of features which are included in the instance and (ii) as explanatory variables, a plurality of subsets of features obtained by excluding the at least one feature from the plurality of features, the subsets being different from each other; and an abnormality degree output means that outputs a degree of abnormality of the instance, with reference to the plurality of prediction results.

### Advantageous Effects of Invention

An example aspect of the present invention can provide a technique that makes it possible to more accurately detect an abnormal instance.

### BRIEF DESCRIPTION OF DRAWINGS

FIG. 1 is a block diagram illustrating a configuration example of an information processing apparatus according to a first example embodiment of the present invention.

FIG. 2 is a flowchart illustrating a flow of an information processing method according to the first example embodiment of the present invention.

FIG. 3 is a block diagram illustrating a configuration example of an abnormality determination apparatus according to a second example embodiment of the present invention.

FIG. 4 is a chart showing an example of instance data.

FIG. 5 is a diagram schematically illustrating a process carried out by a prediction unit.

FIG. 6 is a flowchart illustrating an example of an abnormality determination process carried out by the abnormality determination apparatus.

FIG. 7 is a flowchart illustrating a detailed example of an explanatory variable specification process.

FIG. 8 is a flowchart illustrating a detailed example of a prediction process.

FIG. 9 is a flowchart illustrating a detailed example of an abnormality degree output process.

FIG. 10 is a chart showing an example of prediction rules.

FIG. 11 is a block diagram illustrating a configuration example of an abnormality determination apparatus according to a third example embodiment of the present invention.

FIG. 12 is a flowchart illustrating another example of the prediction process.

FIG. 13 is a diagram illustrating an example of a case in which rules are extracted from a plurality of decision trees.

FIG. 14 is a diagram illustrating an example of a case in which rules are extracted from a plurality of decision trees.

FIG. 15 is a flowchart illustrating still another example of the prediction process.

FIG. 16 is a diagram illustrating narrowing of rules.

FIG. 17 is a block diagram illustrating a configuration example of an abnormality determination/learning apparatus according to a fourth example embodiment of the present invention.

FIG. 18 is a flowchart illustrating an example of a learning process performed by the abnormality determination/learning apparatus.

FIG. 19 is a flowchart illustrating a detailed example of a parameter update process.

FIG. 20 is a block diagram illustrating an example of a computer that executes an instruction of a program which is software for realizing each function.

### DESCRIPTION OF EMBODIMENTS

### First Example Embodiment

The following description will discuss a first example embodiment of the present invention, with reference to drawings. The present example embodiment is a basic form of example embodiments described later.

### <Overview of Information Processing Apparatus 20>

Briefly, an information processing apparatus 20 in accordance with the present example embodiment is an apparatus that predicts whether or not a given instance including a plurality of features is abnormal.

More specifically, the information processing apparatus 20 includes, for example,
an acquisition means that acquires an instance expressed as a set of a plurality of features;
a prediction means that outputs a plurality of prediction results which are obtained by using (i) as a target variable, at least one of the plurality of features which are included in the instance and (ii) as explanatory variables, a plurality of subsets of features obtained by excluding the at least one feature from the plurality of features, the subsets being different from each other; and
an abnormality degree output means that outputs a degree of abnormality of the instance, with reference to the plurality of prediction results.

### <Configuration of Information Processing Apparatus 20>

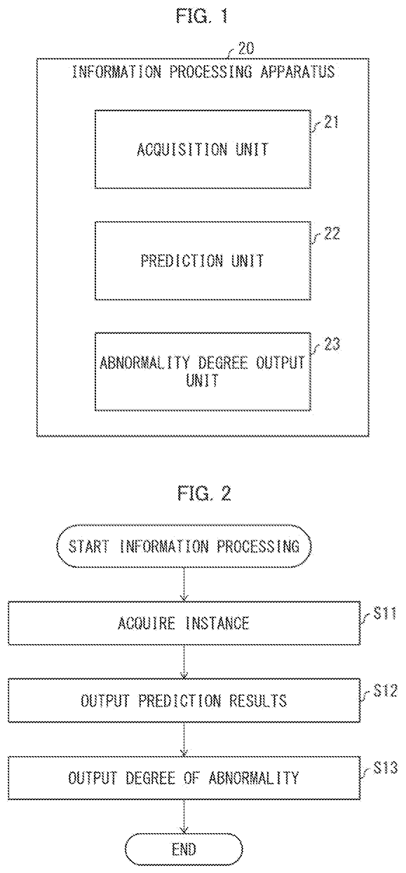

The following will discuss a configuration of the information processing apparatus 20 in accordance with the present example embodiment, with reference to FIG. 1. FIG. 1 is a block diagram illustrating a configuration example of the information processing apparatus 20.

As illustrated in FIG. 1, the information processing apparatus 20 includes an acquisition unit 21, a prediction unit 22, an abnormality degree output unit 23. The acquisition unit 21 is configured to realize an acquisition means in the present example embodiment. The prediction unit 22 is configured to realize a prediction means in the present example embodiment. The abnormality degree output unit 23 is configured to realize an abnormality degree output means in the present example embodiment.

The acquisition unit 21 acquires an instance expressed as a set of a plurality of features.

The prediction unit 22 outputs a plurality of prediction results which are obtained by using (i) as a target variable, at least one of the plurality of features which are included in the instance and (ii) as explanatory variables, a plurality of subsets of features obtained by excluding the at least one feature from the plurality of features, the subsets being different from each other.

For example, in a case where there are D features included in an instance, a subset of the features is a combination of any number (including 0) of D−1 features which are obtained by excluding one feature that corresponds to the target variable.

The abnormality degree output unit 23 outputs a degree of abnormality of the instance, with reference to the plurality of prediction results.

The abnormality degree output unit 23 obtains, for each of the plurality of prediction results, for example, a degree of deviation which indicates how much the prediction result deviates from an actual instance. The abnormality degree output unit 23 calculates and outputs the degree of abnormality which indicates the likelihood that an instance is abnormal, with use of those respective degrees of deviation of the plurality of prediction results.

### <Example Advantage of Information Processing Apparatus 20>

According the information processing apparatus 20 in accordance with the present example embodiment, outputted are a plurality of prediction results which are each obtained by using (i) as a target variable, at least one of a plurality of features which are included in an instance and (ii) as explanatory variables, a plurality of subsets of features obtained by excluding the at least one feature from the plurality of features, the subsets being different from each other. Therefore, an abnormal instance can be detected more accurately. In other words, it is possible to obtain a plurality of prediction results with use of a plurality of subsets different from each other as explanatory variables. Therefore, even in a case where a certain feature becomes an abnormal value and many other features accordingly become abnormal values, the degree of abnormality of the certain feature can be obtained.

### <Flow of Information Processing Method Performed by Information Processing Apparatus 20>

The following will discuss a flow of an information processing method that is performed by the information processing apparatus 20 configured as described above, with reference to FIG. 2. FIG. 2 is a flowchart illustrating a flow of an information processing method. As illustrated in the drawings, information processing includes steps S11 to S13.

In step S11, the acquisition unit 21 acquires an instance expressed as a set of a plurality of features.

In step S12, the prediction unit 22 outputs a plurality of prediction results which are obtained by using (i) as a target variable, at least one of the plurality of features which are included in the instance and (ii) as explanatory variables, a plurality of subsets of features obtained by excluding the at least one feature from the plurality of features, the subsets being different from each other.

In step S13, the abnormality degree output unit 23 outputs a degree of abnormality of the instance, with reference to the plurality of prediction results.

### <Example Advantage of Information Processing Method>

According the information processing method in accordance with the present example embodiment, outputted are a plurality of prediction results which are each obtained by using (i) as a target variable, at least one of a plurality of features which are included in an instance and (ii) as explanatory variables, a plurality of subsets of features obtained by excluding the at least one feature from the plurality of features, the subsets being different from each other. Therefore, an abnormal instance can be detected more accurately. In other words, it is possible to obtain a plurality of prediction results with use of a plurality of subsets different from each other as explanatory variables. Therefore, even in a case where a certain feature becomes an abnormal value and many other features accordingly become abnormal values, the degree of abnormality of the certain feature can be obtained.

### Second Example Embodiment

The following description will discuss a second example embodiment of the present invention, with reference to drawings. Note that components having the same functions as those described in the first example embodiment are denoted by the same reference numerals, and descriptions thereof will be omitted accordingly.

### <Configuration of Abnormality Determination Apparatus 10>

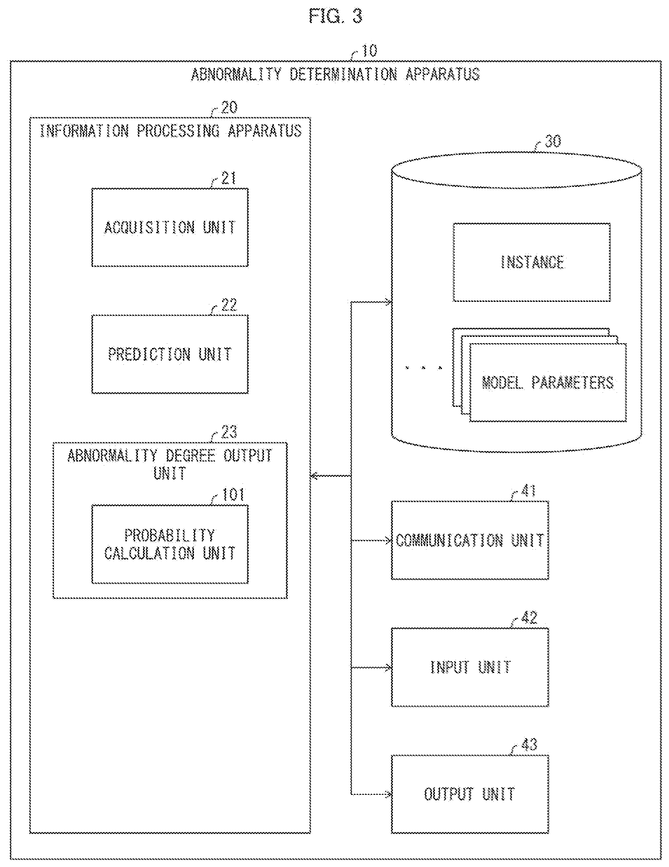

The following will discuss a configuration of an abnormality determination apparatus 10 in accordance with the present example embodiment, with reference to FIG. 3. FIG. 3 is a block diagram illustrating a configuration example of the abnormality determination apparatus 10. As illustrated in FIG. 3, the abnormality determination apparatus 10 includes an information processing apparatus 20, a storage unit 30, a communication unit 41, an input unit 42, and an output unit 43.

The information processing apparatus 20 is a functional block that has the same function as the information processing apparatus 20 described in the first example embodiment.

The storage unit 30 is configured by, for example, a semiconductor memory device or the like and stores data. In this example, instance data and model parameters are stored in the storage unit 30.

Here, the model parameters define a prediction model that is used by the prediction unit 22 for obtaining a prediction result. Examples of the model parameters include a weighting factor, a threshold, and the like that are referred to by the prediction model. In the present example embodiment, for example, a plurality of sets of model parameters are stored in the storage unit 30 as illustrated in FIG. 3. These sets of model parameters are applied, by way of example, to a plurality of respective different prediction models.

The communication unit 41 is an interface for connecting the abnormality determination apparatus 10 to a network. As a specific configuration of the network, it is possible to use, for example, a wireless local area network (LAN), a wired LAN, a wide area network (WAN), a public line network, a mobile data communication network, or a combination of these networks. Note, however, that the present example embodiment is not intended by these examples.

The input unit 42 receives various inputs to the abnormality determination apparatus 10. As a specific configuration of the input unit 42, it is possible to employ, for example, a configuration including an input device such as a keyboard and a touch pad. Note, however, that the present example embodiment is not intended by this example. Further, the input unit 42 may be configured to include, for example, a data scanner that reads data via electromagnetic waves such as infrared rays and electric waves, and a sensor that senses a state of an environment.

The output unit 43 is a functional block that outputs a processing result that is obtained by the abnormality determination apparatus 10. As a specific configuration of the output unit 43, it is possible to employ, for example, a configuration in which a display, a speaker, a printer and the like are provided and various processing results obtained by the abnormality determination apparatus 10 are displayed on a screen and/or outputted as voice or a diagram. Note, however, that the present example embodiment is not intended by the example.

The abnormality determination apparatus 10 according to the present example embodiment stores, in the storage unit 30, sets of model parameters of a plurality of prediction models obtained by machine learning which has been carried out in advance with use of a plurality of instances as training data. The abnormality determination apparatus 10 determines whether or not a given instance is abnormal by predicting a feature of a given instance with use of the prediction models trained in advance.

### (Examples of Instance Data and Subsets)

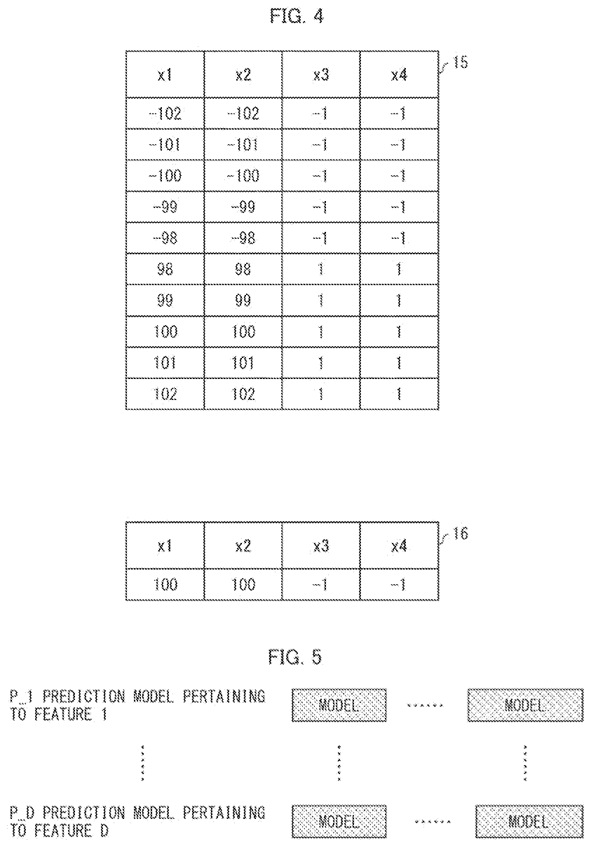

FIG. 4 is a chart showing an example of instance data. In FIG. 4, instance data 15 is arranged in a table format and is configured by a plurality of records having features x1 to x4.

A test instance 16 illustrated in FIG. 4 is considered to be an instance that is subject to determination as to whether or not the instance is abnormal. As described above, the acquisition unit 21 acquires the test instance 16 as an instance expressed as a set of a plurality of features.

For example, in a first instance of the instance data 15, the value of the feature x1 is −102, the value of the feature x2 is −102, the value of the feature x3 is −1, and the value of the feature x4 is −1. In a second instance of the instance data 15, the value of the feature x1 is −101, the value of the feature x2 is −101, the value of the feature x3 is −1, and the value of the feature x4 is −1.

In each of instances instance of the instance data 15, the value of the feature x1 is always equal to the value of the feature x2, and the value of the feature x3 is equal to the value of the feature x4. Further, in each of the instances, the signs of the values of the features x1 to x4 are always positive or negative. An instance that meets this condition is normal, whereas an instance that does not meet the condition is abnormal.

For example, consider a case in which a linear prediction model is trained with use of the value of the feature x1 as a target variable and features other than the feature x1 as explanatory variables. In this case, a trained prediction model is expressed as x1=1*x2+0*x3+0*X4. Here, “*” represents an operation symbol indicating a product. This prediction model makes it possible to predict the value of the feature x1 of each of all the instances in the instance data 15.

With regard to instances that actually exist, it is often difficult to obtain an abnormal instance, and it is difficult to generate, from features of the instances, a prediction model which predicts that an instance is abnormal.

In general, in a case where the value of a feature predicted by a prediction model trained by using, as training data, a sufficiently large number of normal instances is equal to or close to the value of a feature included in an actual instance, such an instance is highly likely to be normal. A reason for this is considered as follows: a correlation between the feature serving as the target variable and the features serving as the explanatory variables is reflected in the prediction model through training; and the feature is predicted so as to satisfy the condition of normal instances.

In other words, in a case where a feature predicted by the prediction model deviates from a feature actually included in an instance, the instance is highly likely to be abnormal. It is possible to thus determine whether or not an instance is abnormal on the basis of a deviation between a feature predicted by the prediction model and a feature actually included in the instance. In this case, even in a case where an abnormal instance is not available, a prediction model can be generated by learning normal instances.

With regard to the test instance 16, although the value of the feature x1 is equal to the value of the feature x2, the values of the features x1 to x4 do not consistently have the positive sign or negative sign. Therefore, the test instance 16 should be determined to be abnormal.

However, when the value of the feature x1 is predicted with the use of the prediction model described above, x1=1*100+0*(−1)+0*(−1). This means that the value of the feature x1 can be correctly predicted. In this way, in a case where the features x1 and x2 concurrently become abnormal with respect to the features x3 and x4, it is not possible to accurately determine abnormality by prediction using a prediction model in which simply, all the features other than the feature x1 are used as explanatory variables.

In light of the above, in the present example embodiment, prediction is performed with use of a prediction model using, as explanatory variables, a plurality of subsets that are different from each other and that each include features which does not include a feature corresponding to a target variable of a feature included in an instance. For example, in the case of the instance data 15, when the feature x1 is used as the target variable, a prediction model that predicts the feature x1 with use of only the feature x3 is also learned.

In this case, a resultant trained prediction model is expressed as x1=100*x3. This prediction model cannot make prediction errors 0 (zero) even in a case where machine learning is carried out in which all of the instances included in the instance data 15 are used as the training data. In other words, the prediction errors caused by this prediction model become 2, 1, 0, 1, and 2, so that values of the prediction errors appear at almost the same frequency. Note that a prediction model which cannot make prediction errors 0 (zero) may also be referred to as a weak prediction model.

In a case where the value of the feature x1 of the test instance 16 is predicted with use of this weak prediction model, x1=−100. This means that the feature x1 cannot be correctly predicted.

In the present example embodiment, as described above, a prediction model that uses some of the features other than the feature corresponding to the target variable is used. In other words, a weak prediction model is deliberately used to output a prediction result in which a predicted feature deviates more from the feature actually included in an instance. Then, whether or not the instance is abnormal is determined with use of the prediction result.

This makes it possible to appropriately determine abnormality, for example, even for an instance in which a certain feature becomes an abnormal value and many other features accordingly become abnormal values.

Here, as an example, prediction using a linear prediction model has been described. However, it is possible to use a prediction model for a method which differs from that using the linear prediction model. For example, a prediction model of a nonlinear SVM, a decision tree, or the like may be used. Alternatively as described later, a prediction rule may be used instead of a prediction model.

The subsets of the features and the prediction models in the present example embodiment are specifically determined as follows. For example, in a case where there are four features x1 to x4 in an instance and x4 is used as a target variable, there are the following 8 combinations of explanatory variables.
[ ]
[x1], [x2], [x3]
[x1, x2], [x1, x3], [x2, x3]
[x1, x2, x3]

Note that [ ] represents a case in which 0 (zero) features are included in the instance.

According to the present example embodiment, the prediction unit 22 outputs a plurality of prediction results with use of respective prediction models corresponding to the subsets. This makes it possible to obtain prediction results with use of weak prediction models.

Here, the prediction models are to differ from each other depending on the above-described combinations of the explanatory variables. However, a plurality of prediction models using one combination of explanatory variables may be used. For example, a prediction model of an SVM in which the explanatory variables are [x1, x2, x3] and a prediction model of a decision tree in which the explanatory variables are [x1, x2, x3] may each be used. That is, one or more prediction models or prediction rules are used for each of the subsets.

Further, a plurality of prediction results from features may be used in determining whether or not an instance is abnormal. For example, in a case where features of an instance are x1 to x8, it is possible to use a plurality of prediction results as follows from features may be used: a prediction result obtained by using x1 as the target variable and using a subset of x2 to x8 as the explanatory variables; a prediction result obtained by using x2 as the target variable and a subset of x1 and x3 to x8 as the explanatory variables; and the like.

In this way, it is possible to more accurately determine whether or not the instance is abnormal.

Further, in consideration of the relevance between the feature serving as the target variable and the features serving as the explanatory variables, it is possible to achieve more accurate determination.

For example, consider a case where a plurality of sensors are provided from upstream to downstream of a water pipe. At this time, when water leakage occurs at an upstream portion of the water pipe, downstream sensors has abnormal values at the same time. In this case, the features outputted from the sensors have a high degree of relevance to each other and it may be possible to predict each of the features from another feature or other features.

Therefore, for example, it is possible to have a configuration in which: relevance is given in advance between a plurality of features included in an instance; and a subset used as explanatory variables is configured by features that each have a relatively low degree of relevance with respect to the feature corresponding to the target variable.

Thus, even in a case where many features simultaneously become abnormal, it is possible to use a prediction model that can output a prediction result in which the feature of the target function deviates from the features actually included in the instance. This makes it possible to reduce the possibility that an abnormal instance may be erroneously determined to be normal.

Note that the prediction models or prediction rules is defined by a plurality of respective sets of model parameters stored in the storage unit 30.

The abnormality degree output unit 23 calculates and outputs a degree of abnormality indicating the likelihood that a given instance is abnormal, with use of prediction results that are outputted as described above. Note that details of calculation of the degree of abnormality will be described later.

### (Example of Reduction of Number of Prediction Models)

On the other hand, carrying out machine learning of all of these prediction models significantly increases computation cost. Further, the use of too many prediction models also reduces interpretability, which is the possibility of posterior recognition of a reason why an instance has been determined to be abnormal.

Therefore, the number of prediction models may be reduced. For example, the number of prediction models may be reduced by limiting the number of subsets or by limiting the number of features constituting the subsets.

For example, it is possible to have a configuration in which: the acquisition unit 21 acquires information pertaining to the relevance; and the prediction unit 22 identifies, with reference to the information pertaining to the relevance, features that each have a relatively low degree of relevance with respect to the at least one feature, and configures a subset with use of the features identified.

In this case, since the features constituting the subsets are limited to the features that each have a relatively low degree of relevance, the number of features is limited, and thus the number of prediction models can be reduced. For example, four combinations can be selected from among eight combinations of features. Then, the number of prediction models can be reduced by having a configuration where prediction is made with use of only respective prediction models for which the combinations selected are used as the explanatory variables.

This makes it possible to avoid an enormous number of prediction models. This consequently reduces computation cost and enhances interpretability.

In the above example, the number of prediction models is reduced by configuring the explanatory variables by the features that each have a relatively low degree of relevance with respect to the feature corresponding to the target variable. However, the number of prediction models may be reduced by another method. For example, the explanatory variables may be configured by only a predetermined number of features arbitrarily selected from among the features other than the feature corresponding to the target variable. Then, the number of prediction models may be reduced by repeating this selection.

In other words the prediction unit 22 may randomly select one or more features from the features from which the feature corresponding to the target variable is excluded, and may output a plurality of prediction results by using, as the explanatory variables, each of subsets obtained by repeating such arbitrary selection.

In this case, since the number of subsets is limited by limiting the number of times the selection is repeated, it becomes possible to reduce the number of prediction models. In this way, it is possible to avoid an enormous number of prediction models. This consequently reduces computation cost and enhances interpretability.

An example of an algorithm for generating a prediction model by repeating random selection of features is expressed as follows with use of a pseudo code. Here, L represents the number of features, and an algorithm for repeating selection T times is shown.

| models = [ ] | |
|---|---|
| for i in range(L): | |
| models [i] = [ ] | |
| for j in range (T): | # T represent an |

| appropriate constant determined in advance. | |
|---|---|
| features = random_select (i, L, K) | # |

| Randomly select K features from L-1 features other | |
|---|---|
| than feature i. | |
| models [i][j] = training (i, features) | # |

Create models each for predicting a frature x_i from
selected features, on this basis of sets of training instances.

In this example, the smaller the number of times T of selection becomes, the smaller the number of prediction models becomes.

### (Outline of Process Carried Out by Prediction Unit)

FIG. 5 is a diagram schematically illustrating a process carried out by the prediction unit 22 in the above-described present example embodiment. In this example, it is assumed that D features 1 to D are present as features included in an instance.

As illustrated in FIG. 5, the prediction unit 22 carries out a prediction process using P_1 prediction models in order to predict a feature 1. Further, the prediction unit 22 carries out a prediction process using P_2 prediction models in order to predict a feature 3, carries out a prediction process using P_3 prediction models in order to predict a future 3, . . . , carries out a prediction process using P_D prediction models in order to predict a feature D.

### <Flow of Abnormality Determination Process Carried Out by Abnormality Determination Apparatus 10>

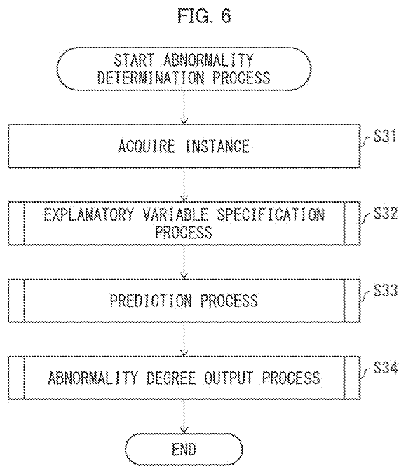

Next, the following will discuss an example of an abnormality determination process carried out by the abnormality determination apparatus 10 of the present example embodiment, with reference to a flowchart of FIG. 6.

In step S31, the acquisition unit 21 acquires an instance which is subject to determination as to whether or not the instance is abnormal.

In step S32, the prediction unit 22 carries out an explanatory variable specification process. As a result, explanatory variables for predicting a feature corresponding to a target variable in the instance acquired in step S31 are specified.

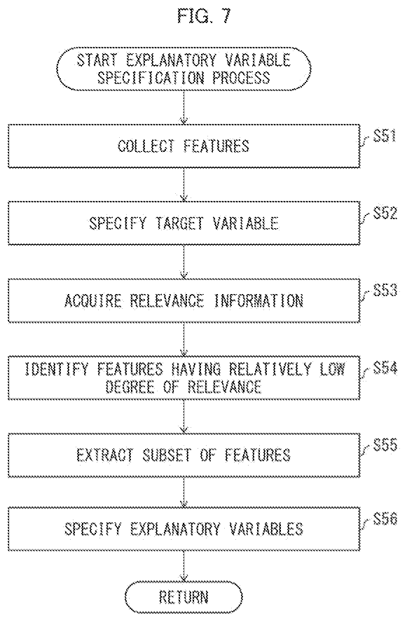

Here, a detailed example of the explanatory variable specification process of step S32 of FIG. 6 will be described with reference to a flowchart of FIG. 7.

In step S51, the prediction unit 22 collects features of the instance acquired in step S31. For example, when D features are included in the instance, D features are collected.

In step S52, the prediction unit 22 specifies a feature that serves as the target variable. The feature serving as the target variable may be arbitrarily selected or may be specified in advance. In a case where the feature which serves as the target variable is specified in advance, the feature is specified by, for example, an operation received via the input unit 42 or predetermined information.

In step S53, the acquisition unit 21 acquires relevance information which is information indicating the relevance between a plurality of features included in the instance. Examples of the relevance information includes information in which a degree of correlation between features obtained by analyzing instance data in advance is described.

The acquisition unit 21 acquires the relevance information via, for example, the input unit 42 or the communication unit 41. Alternatively, the relevance information may be stored in advance in the storage unit 30.

In step S54, the prediction unit 22 identifies features that each have a relatively low degree of relevance with respect to the feature of the target variable specified in the process of step S52, with reference to the relevance information acquired in the process of step S53.

In step S55, the prediction unit 22 extracts a plurality of subsets of features with use of the features that each have a relatively low degree of relevance and that are identified in the process of step S54. At this time, a plurality of combinations of features including some or all of the features identified in the process of step S54 are extracted.

In step S56, the prediction unit 22 specifies the subsets of the features extracted in the process of step S55 as the explanatory variables for predicting the target variable specified in the process of step S52. At this time, each of the plurality of subsets is specified as an explanatory variable. That is, a plurality of combinations of the explanatory variables corresponding to the plurality of prediction models are specified.

The explanatory variable specification process is carried out as described above.

In the case of the example explained here, features each having a relatively low degree of relevance with respect to a feature of a target variable are identified, and a subset which serves as explanatory variables is extracted from the features identified. However, the subset serving as the explanatory variables may be extracted in a different manner. For example, one or more features may be randomly selected from the features from which the feature corresponding to the target variable is excluded, and subsets obtained by repeating such selection may be extracted.

With reference back to FIG. 6, after the process of step S32, the prediction unit 22 carries out the prediction process of step S33. As a result, prediction of the target variable using the explanatory variables specified in the process of step S56 is carried out.

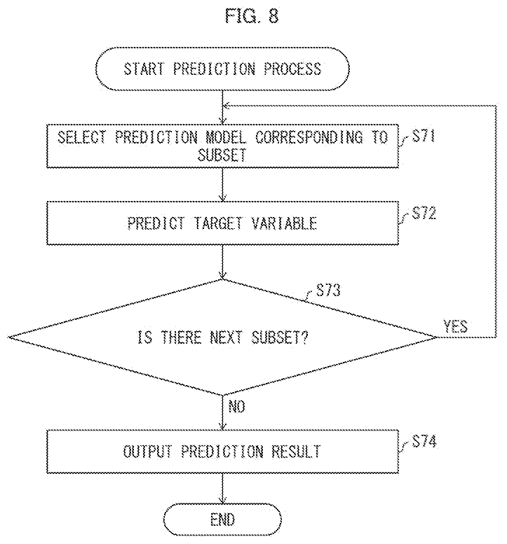

Here, a detailed example of the prediction process of step S33 of FIG. 6 will be described with reference to a flowchart of FIG. 8.

In step S71, the prediction unit 22 selects a prediction model corresponding to a subset. At this time, a prediction model corresponding to the subset of the features (i.e., explanatory variables) extracted in the process of step S55 is selected. Note that as described above, a plurality of prediction models using one combination of the explanatory variables may be selected. The plurality of prediction models are defined by the sets of model parameters stored in advance in the storage unit 30.

In step S72, the prediction unit 22 predicts the target variable with use of the prediction model selected in the process of step S71.

In step S73, the prediction unit 22 determines whether or not there is a next subset. In a case where it is determined that there is a next subset, the process returns to step S71. Then, a prediction model corresponding to the next subset is selected and the target variable is predicted. In this way, a plurality of prediction results corresponding to the plurality of subsets are obtained.

In step S73, in a case where it is determined that there is no next subset, the process proceeds to step S74 and the prediction unit 22 outputs the above-described plurality of prediction results. Thus, the plurality of prediction results described above are outputted.

As described above, the prediction process is carried out.

With reference back to FIG. 6, after the process of step S33, the process proceeds to step S34 and the abnormality degree output unit 23 carries out an abnormality degree output process. As a result, the degree of abnormality of the instance acquired in step S31 is calculated and outputted.

As illustrated in FIG. 3, the abnormality degree output unit 23 of the present example embodiment includes a probability calculation unit 101. The probability calculation unit 101 compares, with the prediction result, the true value which is a value of the feature corresponding to the target variable. The probability calculation unit 101 thus calculates a probability value p indicating the likelihood of a true value. Note that the probability value p is calculated for each of the plurality of prediction results.

With use of the probability value thus calculated, an appropriate degree of abnormality can be calculated in order to determine whether or not the instance is abnormal.

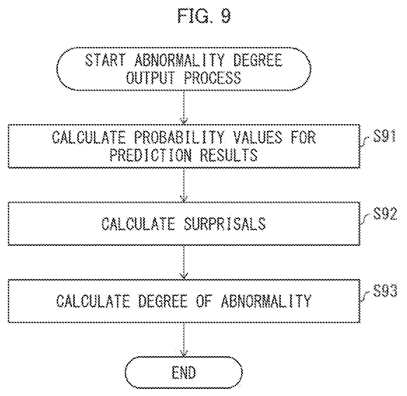

Next, a detailed example of the abnormality degree output process in step S33 of FIG. 6 will be described with reference to a flowchart of FIG. 9.

Here, the number of features x included in an instance is D, and subsets of features are expressed as follows.

$${ρ}_{i 1} ( x ) = 〈 〉 \qquad ( 1 )$$

$${ρ}_{i 2} ( x ) = 〈 {x}_{1} 〉$$

$${ρ}_{i 3} ( x ) = 〈 {x}_{1} , {x}_{2} 〉$$

$$⋮$$

$$⋮$$

$${ρ}_{iPi} ( x ) = 〈 {x}_{1} , {x}_{2} , … , {x}_{i - 1} , {x}_{i + 1} , … , {x}_{D} 〉$$

Note that the number of the subsets of features which constitute the explanatory variables is expressed by Pi.

Then, respective prediction models corresponding to the subsets are assumed to be expressed by Ci1, Ci2, Ci3, . . . CiPi.

In step S91, the probability calculation unit 101 calculates a probability value p for each of the plurality of prediction results outputted in the process of step S74.

In step S92, the abnormality degree output unit 23 calculates a surprisal, which is a parameter used for calculation of the degree of abnormality, on the basis of the probability value p calculated in the process of step S91. Note that the surprisal is calculated for each of probability values p calculated in step S91. In other words, the surprisal is also calculated for each of the plurality of prediction results.

The surprisal is regarded as a value that represents unexpectedness of each of the prediction results. The smaller the probability value p is, the larger the value becomes. The surprisal is expressed by the following formula.

$$surprisal ( p ) = - log ( p ) . \qquad ( 2 )$$

In step S93, the abnormality degree output unit 23 calculates the degree of abnormality S with use of the surprisal calculated in step S92. At this time, the degree of abnormality is calculated by, for example, the following formula.

$$S ( C , x ) = {\sum }_{i = 1}^{D} {\sum }_{p = 1}^{{P}_{i}} surprisal ( P ( {x}_{i} \vert {C}_{ip} , {ρ}_{ip} ( x ) ) ) \qquad ( 3 )$$

As a result, the degree of abnormality S is calculated by adding up surprisals which have been calculated in the process of step S92.

On the other hand, many of a plurality of prediction results outputted in the process of step S74 may have low unexpectedness. That is, in step S92, most values of the surprisals calculated may become small. In such a case, the prediction result of a case where the target variable could not be accurately predicted is not effectively used in calculation of the degree of abnormality.

In light of the above, for example, the degree of abnormality may be calculated with use of a surprisal corresponding to a prediction result whose unexpectedness is the highest. In this case, the degree of abnormality is calculated by, for example, the following formula.

$$S ( C , x ) = {max}_{1 \leq i \leq D} {max}_{1 \leq p \leq {P}_{i}} surprisal ( P ( {x}_{i} \vert {C}_{ip} , {ρ}_{ip} ( x ) ) ) \qquad ( 4 )$$

In this example, the degree of abnormality is calculated with use of a surprisal corresponding to a prediction result whose unexpectedness is the highest, that is, a maximum value of the surprisal. However, it is possible to use, for example, surprisals corresponding to k prediction results taken from highest unexpectedness in the descending order of unexpectedness. Note that k is an arbitrary constant, for example, 3.

In other words, the degree of abnormality may be calculated by computation using k probability values p (where k is a natural number) taken in the ascending order from the smallest value from among the probability values p of the plurality of prediction results.

In this way, a more stable degree of abnormality can be calculated as compared with a case where the maximum value of the surprisal is simply used. In other words, not one prediction result but three prediction results are reflected in the degree of abnormality, and therefore, for example, an extreme change in the degree of abnormality depending on an instance is likely to be avoided.

Alternatively, the degree of abnormality may be calculated by weighting. In the weighting, attention is paid to the number of explanatory variables used in prediction. For example, an instance in which a target variable cannot be accurately predicted in prediction using only a small number of explanatory variables is often an immediately obviously abnormal instance.

In light of the above, it is possible to calculate the degree of abnormality, by computation using a plurality of probability values and a weighting factor that weights the plurality of probability values in such a manner that when the number of the explanatory variables used for obtaining the prediction results corresponding to the probability values is larger, the probability values are less weighted. In this case, the degree of abnormality is calculated by, for example, the following formula.

$$( 5 )$$

$$S ( C , x ) = {max}_{1 \leq i \leq D} {max}_{1 \leq p \leq {P}_{i}} \frac{1}{\vert {ρ}_{ip} ( x ) \vert} surprisal ( P ( {x}_{i} \vert {C}_{ip} , {ρ}_{ip} ( x ) ) ) where the number of explanatory variables included in {ρ}_{ip} ( x ) is defined as \vert {ρ}_{ip} ( x ) \vert .$$

This reduces the possibility that an immediately obvious abnormal instance will be erroneously determined to be normal. As a result, a more accurate determination of abnormality becomes possible.

As described above, the degree of abnormality is carried out. Further, as a result, the abnormality degree determination process of FIG. 6 ends. The degree of abnormality calculated in step S93 indicates the likelihood that an instance is abnormal. Therefore, whether or not the instance is abnormal can be determined by, for example, comparing a value of the degree of abnormality with a threshold value.

### <Example Advantage of Abnormality Determination Processing Apparatus and Abnormality Determination Process>

As described above, in the abnormality determination processing apparatus and the abnormality determination process according to the present example embodiment, prediction is carried out with use of prediction models using, as explanatory variables, a plurality of subsets of features. These subsets are different from each other and are each obtained from features included in an instance from which a feature corresponding to a target variable is excluded. This makes it possible to deliberately use a weak prediction model and to more appropriately calculate the degree of abnormality. As a result, it is possible to more accurately determine whether or not the instance is abnormal.

### Third Example Embodiment

The second example embodiment has discussed an example in which a prediction unit 22 mainly carries out prediction using prediction models. However, the prediction unit 22 may carry out prediction using prediction rules.

(Example of Prediction Rules Extracted from Single Decision Tree)

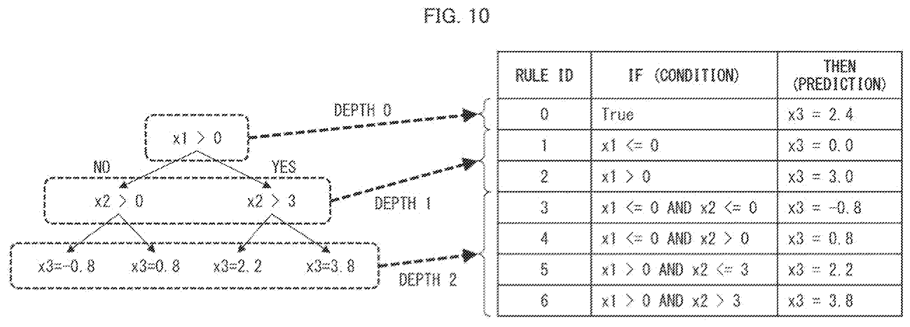

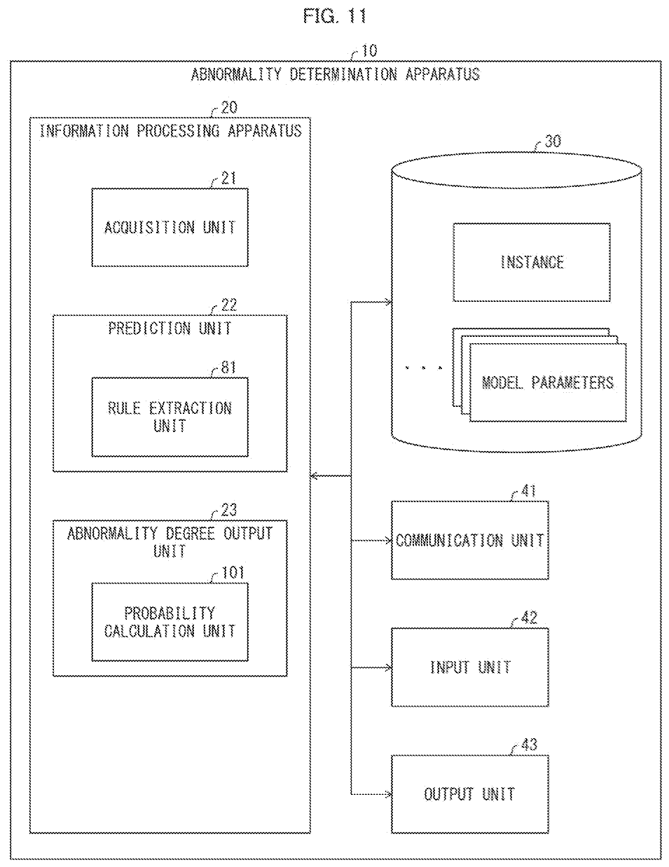

FIG. 10 is a diagram illustrating an example of prediction rules in an example embodiment. FIG. 10 shows an example of extracting rules from a single decision tree that predicts a feature x3 with use of a feature x1 and a feature x2.

This decision tree has one internal node at depth 0, two internal nodes at depth 1, and four internal nodes at depth 2, that is, has seven internal nodes in total. Here, each of those internal nodes can be regarded as one IF-THEN rule.

That is, the internal node at depth 0 can be regarded as an IF-THEN rule of rule ID 0. In addition, the internal nodes at depth 1 can be regarded as IF-THEN rules of rule IDs 1 and 1. Furthermore, an internal node at depth 2 can be regarded as IF-THEN rules of rule IDs 3 to 6.

The IF-THEN rules each can also be considered to be an incomplete prediction model that outputs a prediction only in a case where an instance meets a condition and in any other cases, does not output any prediction.

### <Configuration of Abnormality Determination Apparatus 10>

FIG. 11 is a block diagram illustrating a configuration example of the abnormality determination apparatus 10 in the present example embodiment. As illustrated in FIG. 11, in the present example embodiment, the prediction unit 22 includes a rule extraction unit 81. The rule extraction unit 81 extracts rules from respective nodes included in a decision tree trained with reference to features which are obtained by excluding a feature corresponding to a target variable from among a plurality of features. Then, the prediction unit 22 outputs a prediction result with use of each of the rules extracted. Since the other configurations in FIG. 11 are the same as those in FIG. 3, a detailed description thereof will be omitted.

<Flow of Prediction Process in Case where Single Decision Tree is Used>

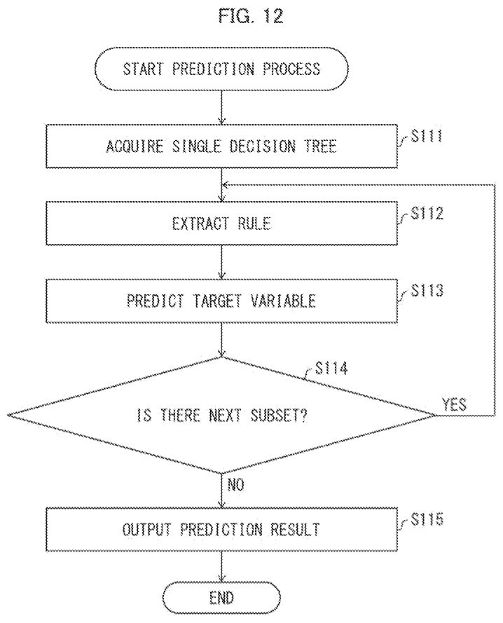

Next, an example of a prediction process that is carried out in step S33 of FIG. 6 by the prediction unit 22 illustrated in FIG. 11 will be described with reference to a flowchart of FIG. 12.

In step S111, the prediction unit 22 acquires a single decision tree for predicting a target variable. The decision tree is used, for example, as a prediction model for predicting the target variable with use of all features from which a feature corresponding to the target variable from features included in an instance is excluded. The prediction model of this decision tree is defined by model parameters stored in advance in the storage unit 30.

In step S112, the rule extraction unit 81 of the prediction unit 22 extracts a rule. At this time, extracted is for example, a rule including a subset of features corresponding to explanatory variables which are specified by the explanatory variable specification process in step S32 described with reference to FIG. 6.

In step S113, the prediction unit 22 predicts the target variable with the rule extracted in step S112.

In step S114, the prediction unit 22 determines whether or not there is a next subset. In a case where it is determined that there is a next subset, the process returns to step S112. Then, a rule corresponding to the next subset is selected and the target variable is predicted. In this way, a plurality of prediction results corresponding to the plurality of subsets are obtained.

In step S112, in a case where it is determined that there is no next subset, the process proceeds to step S115 and the prediction unit 22 outputs the above-described plurality of prediction results. Thus, the plurality of prediction results are outputted.

The prediction process in the present example embodiment is carried out as described above. As described above, computation cost is reduced because the prediction results are obtained with use of the rules extracted from the respective nodes included in the decision tree.

(Example of Prediction Rules Extracted from Plurality of Decision Trees)

The above has described, as one example, an example in which rules are extracted from a single decision tree for predicting a target variable with use of all features from which a feature corresponding to the target variable is excluded. However, the rules may be extracted from a plurality of decision trees.

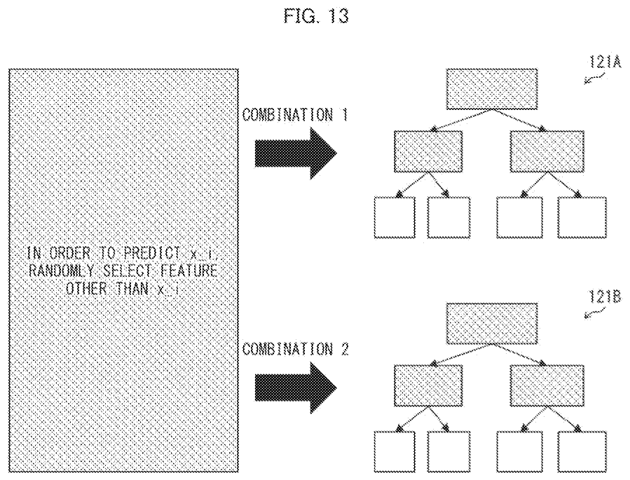

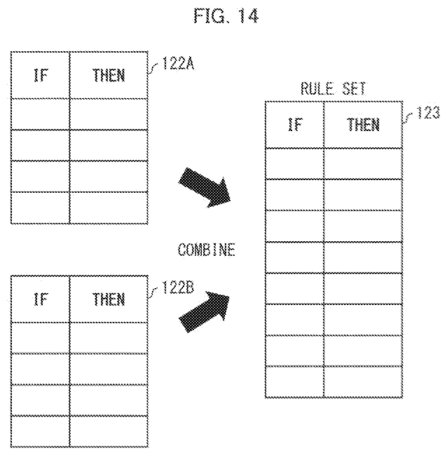

For example, as illustrated in FIGS. 13 and 14, features which serve as explanatory variables for predicting a feature x_i as the target variable may be randomly selected from among features other than the feature x_i, so that a decision tree corresponding to each of the explanatory variables may be used. FIGS. 13 and 14 are diagrams each illustrating an example of a case in which rules are extracted from a plurality of decision trees.

For example, it is assumed that there are features x1 to x8 and the feature x1 is a target variable. In this case, the features that serve as the explanatory variables are the features x2 to x8, and one or more features are randomly selected from the features x2 to x8.

For example, it is assumed that the features x2, x3, and x4 are selected as a combination 1 and the features x6, x7, and x8 are selected as a combination 2. In this case, a decision tree 121A is generated so as to correspond to the combination 1, and a decision tree 121B is generated so as to correspond to the combination 2.

Then, respective IF-THEN rules are extracted from the decision trees 121A and 121B. For example, as illustrated in FIG. 14, an IF-THEN rule 122A is extracted from the decision tree 121A and an IF-THEN rule 122B is extracted from the decision tree 121B.

The IF-THEN rule 122A and the IF-THEN rule 122B which are extracted as described above are combined to generate a rule set 123. The rule set 123 is a set of IF-THEN rules which are explanatory variables for predicting the feature x1 and which use a subset of the features x2 to x8 as the explanatory variables.

<Flow of Prediction Process in Case where Plurality of Decision Trees are Used>

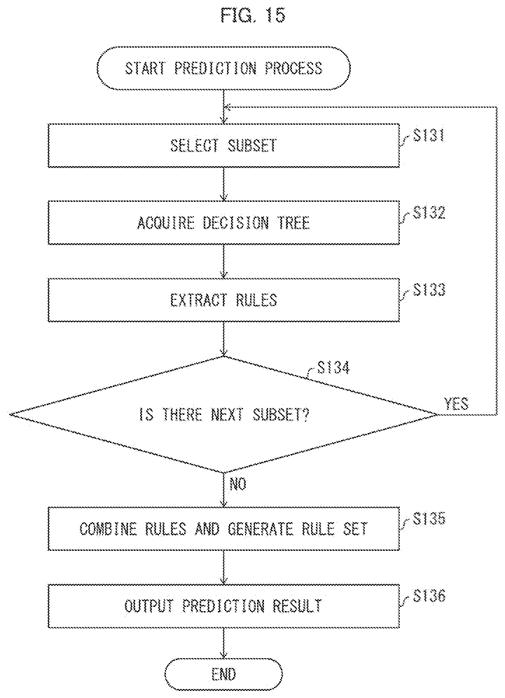

Next, the following will discuss an example of a prediction process for a case in which the prediction unit 22 predicts a target variable with use of rules which are extracted from a plurality of decision trees, with reference to a flowchart of FIG. 15.

In step S131, the prediction unit 22 selects a subset of features. At this time, for example, features which serve as explanatory variables are randomly selected from among all features which are obtained by excluding the feature corresponding to the target variable from among the features included in the instance.

In step S132, the prediction unit 22 acquires a decision tree for predicting the target variable. The decision tree is used as a prediction model for predicting the target variable with use of the features selected in step S131. The prediction model of the decision tree is defined by model parameters stored in advance in the storage unit 30.

In step S133, the rule extraction unit 81 of the prediction unit 22 extracts rules from the decision tree acquired in step S132.

In step S134, the prediction unit 22 determines whether or not there is a next subset. In a case where it is determined that there is a next subset, the process returns to step S131 in which a decision tree corresponding to the next subset is obtained and rules are extracted. In this way, the rules are extracted from each of the plurality of decision trees.

In step S134, in a case where it is determined that there is no next subset, the process proceeds to step S135.

In step S135, the prediction unit 22 generates a rule set by combining the rules extracted in step S133.

In step S136, the prediction unit 22 predicts the feature serving as the target variable, with use of the rule set generated in the process of step S135. As a result, a plurality of respective prediction results are outputted so as to correspond to the rules included in the rule set.

As described above, the prediction process is carried out.

### (Example of Narrowing of Prediction Rules)

In the example described with reference to FIGS. 13 and 14, in the prediction carried out, the rule set in which the rules from the plurality of decision trees are combined is directly used. However, such a rule set may include a plurality of rules that are redundant or that are less useful for prediction.

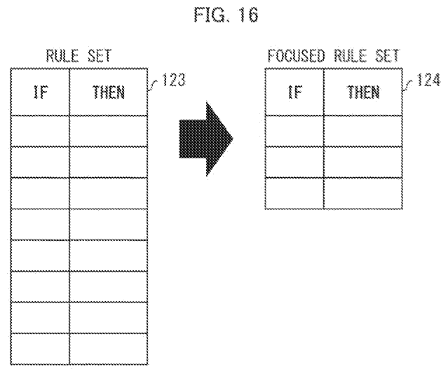

For example, as illustrated in FIG. 16, the prediction unit 22 may exclude rules that are redundant and rules that are less useful for prediction so as to narrow down rules included in the rule set 123, and then may generate a focused rule set 124.

As an example of a method of narrowing down rules, it is possible to use a technique disclosed in “Yuzuru Okajima, Kunihiko Sadamasa. Decision List Optimization based on Continuous Relaxation: The SIAM International Conference on Data Mining (SDM19), 2019”. This technique uses the stochastic gradient descent (SGD) method and, using a rule set as an input, outputs a list of rules (decision lists) which consist only of rules that are useful for prediction.

In this way, the prediction unit 22 may select a plurality of rules that are to be used to output the prediction results, by narrowing down the rules to a smaller number of rules which are obtained by excluding redundant rules from the rules extracted. The reduction of the number of rules further reduces the computation cost.

An example of an algorithm that generates a focused rule set is expressed as follows with use of a pseudo code. Here, it is assumed that there are D features included in an instance and that a set R_i of prediction rules is obtained for the feature x_i.

rulesets = [ ]
for i in [1, ..., D]:

| | |
|---|---|
| ruleset_i = [ ] | # A set R_i of rules for |
| predicting x_i. | |
| for j in [1, ..., T]: | # T is an appropriate |

constant determined in advance.

| | |
|---|---|
| features = random_select (i, L, K) | # |

Randomly select K features from D-1 features other than a
feature i.

| | |
|---|---|
| tree = training (i, features) | Create a |

decision tree for predicting a feature x_i with features selected,
on the basis of a training instance set.

| | |
|---|---|
| rules = get_rules_from_tree (tree) | # |
| Extract rules from the decision tree. | |
| ruleset_i.append (rules) | # Add, to R_i |
| extracted rules. | |
| rulesetset [i] = filter (ruleset_i) | # Narrow |
| down the rule set. | |

An example of an algorithm that is for calculating the degree of abnormality of an instance x and that is given with use of a focused rule set is expressed as follows with use of a pseudo code. Here, as the instance, a vector having D elements, x=[x1, x2, . . . ], is input.

surprisals = [ ]

| | |
|---|---|
| for i in [1, ..., D]: | # Regarding D features. |
| rules = get_applicable (rulesets [i]) | # |

Extract rules that are met by x_i, from the rule set R_i.

| | |
|---|---|
| error = get_error (rules.predict, x_i) | # |

Calculate an error between a prediction value obtained by

| | |
|---|---|
| the rules and x_i) | |
| surprisals [i] = get_surprisal (error) | # |

Calculate a surprisal of the feature from the error.

| | |
|---|---|
| score = get_anomaly_score (surprisals) | # Calculate |

the degree of abnormality of and instance from D features.

### Fourth Example Embodiment

Next, the following description will discuss a fourth example embodiment of the present invention in detail with reference to the drawings. Note that components having the same functions as those described in any of the first example embodiment to the third example embodiment are denoted by the same reference numerals, and descriptions thereof will be omitted accordingly.

### <Configuration of Abnormality Determination/Learning Apparatus 10A>

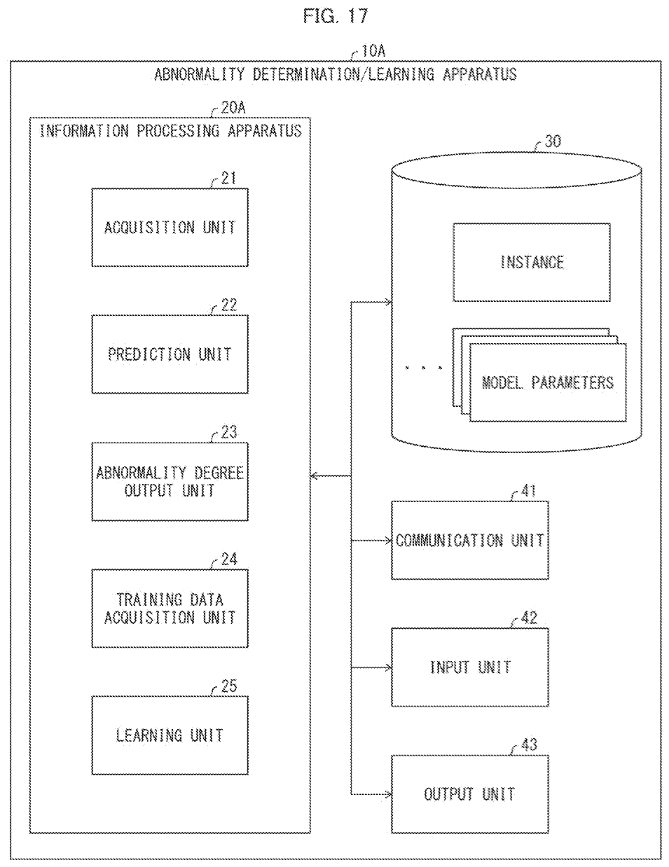

The following will discuss a configuration of an abnormality determination/learning apparatus 10A in accordance with the present example embodiment, with reference to FIG. 17. The abnormality determination/learning apparatus 10A is an apparatus that further has a function of learning a set of model parameters stored in the storage unit 30 of the abnormality determination apparatus 10.

As illustrated in FIG. 17, the abnormality determination/learning apparatus 10A includes an information processing apparatus 20A. The information processing apparatus 20A includes an acquisition unit 21, a prediction unit 22, an abnormality degree output unit 23, as in the information processing apparatus 20 illustrated in FIG. 3, and also includes a training data acquisition unit 24 and a learning unit 25. Other configurations of the abnormality determination/learning apparatus 10A are the same as those of the abnormality determination apparatus 10 illustrated in FIG. 3.

The training data acquisition unit 24 included in the information processing apparatus 20A acquires training data with reference to instance data. The learning unit 25 carries out machine learning using the training data acquired by the training data acquisition unit 24 and trains the prediction model.

### <Flow of Learning Process Carried Out by Abnormality Determination/Learning Apparatus 10A>

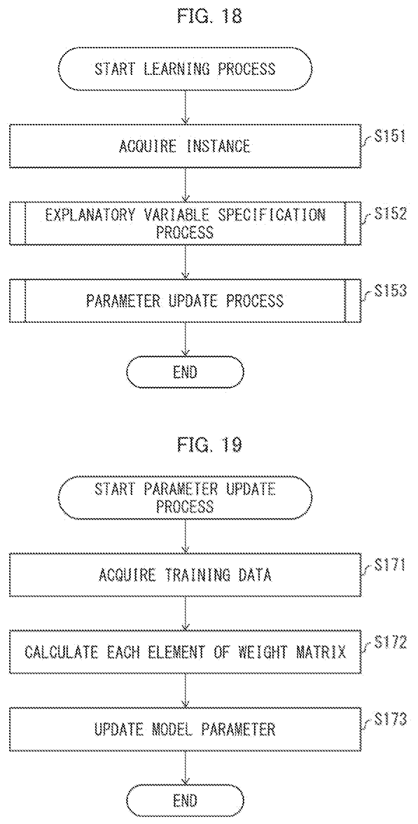

FIG. 18 is a flowchart illustrating an example of a learning process carried out by the abnormality determination/learning apparatus 10A.

In step S151, the training data acquisition unit 24 acquires instances. At this time, a plurality of instances that are subject to learning are acquired.

In step S152, the training data acquisition unit 24 carries out an explanatory variable specification process. As a result, explanatory variables to be used in prediction of a target variable is specified. Since this process is the same as the process described with reference to FIG. 7, a detailed description thereof will be omitted. The training data acquisition unit 24 may control the prediction unit 22 and cause the prediction unit 22 to carry out the explanatory variable specification process in step S152.

Note that in the explanatory variable specification process in step S152, a plurality of explanatory variables corresponding to a plurality of prediction models are specified as described above with reference to FIG. 7.

Further, in step S152, the explanatory variables are specified for each of the plurality of instances acquired in step S151.

In step S153, the training data acquisition unit 24 and the learning unit 25 carry out a parameter update process.

Here, a detailed example of the parameter update process in step S153 of FIG. 18 will be described with reference to a flowchart of FIG. 19.

In step S171, the training data acquisition unit 24 acquires training data including a set of a feature corresponding to the target variable and features corresponding to the explanatory variables. At this time, for example, the feature corresponding to the target variable specified in step S52 of FIG. 7 and the features corresponding to the explanatory variables specified in step S56 are extracted from the instances acquired in step S151 of FIG. 18 and are used as the training data.

Note that a plurality of respective pieces of training data are acquired so as to correspond to the plurality of instances acquired in step S151.

In step S172, the learning unit 25 calculates each element of a weighting matrix with use of the training data acquired in step S171. At this time, for example, each element of the weighting matrix by which the explanatory variables are multiplied is calculated in order to predict the target variable. At this time, such an element of the weighting matrix used for multiplication is calculated for each of a plurality of combinations of the explanatory variables. Each calculated element of the weighting matrix constitutes a set of model parameters.

Note here that although an example of a case in which a target variable is obtained by a linear prediction model is described here as an example, a prediction model for another method may be used. In other words, it is only necessary that a set of model parameters of the prediction model can be calculated in step S172.

In step S173, the learning unit 25 updates the model parameters.

Note that the processes of step S172 and step S173 are carried out a plurality of times in accordance with the number of pieces of the training data acquired in step S171, and the model parameters are updated repeatedly. In this way, the training of the prediction model proceeds as the model parameters are updated.

The parameter update process is carried out as described above. When the parameter update process ends, the learning process of FIG. 18 ends, and a set of model parameters of a plurality of prediction models used for predicting one target variable is obtained. The learning process is carried out a plurality of times with use of different target variables. This results in acquisition of a set of model parameters of the prediction model to be used in the prediction process that is carried out in step S33 of FIG. 6.

### <Example Advantage of Abnormality Determination/Learning Apparatus and Learning Process>

In this way, according to the abnormality determination/learning apparatus and the learning process according to the present example embodiment, model parameters of a prediction model to be used in the prediction process can be acquired. Further, the prediction process can be carried out with use of the prediction model of the model parameters acquired, and whether or not an instance is abnormal can be determined.

### [Software Implementation Example]

The functions of part of or all of the information processing apparatus 20, the abnormality determination apparatus 10, and the abnormality determination/learning apparatus 10A can be realized by hardware such as an integrated circuit (IC chip) or can be alternatively realized by software.

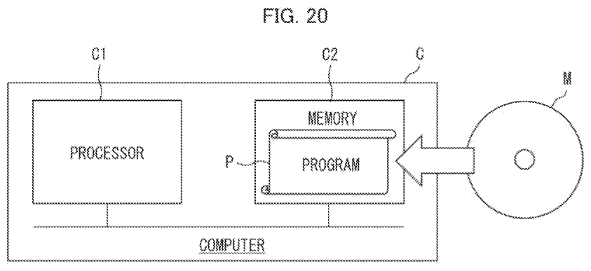

In the latter case, each of the information processing apparatus 20, the abnormality determination apparatus 10, and the abnormality determination/learning apparatus 10A is realized by, for example, a computer that executes instructions of a program that is software realizing the foregoing functions. FIG. 20 illustrates an example of such a computer (hereinafter referred to as “computer C”).

The computer C includes at least one processor C1 and at least one memory C2. In the memory C2, a program P for causing the computer C to operate as the information processing apparatus 20, the abnormality determination apparatus 10, or the abnormality determination/learning apparatus 10A is stored. In the computer C, the foregoing functions of the information processing apparatus 20, the abnormality determination apparatus 10, or the abnormality determination/learning apparatus 10A can be realized by the processor C1 reading and executing the program P stored in the memory C2.

Examples of the processor C1 encompass a central processing unit (CPU), a graphic processing unit (GPU), a digital signal processor (DSP), a micro processing unit (MPU), a floating point number processing unit (FPU), a physics processing unit (PPU), a microcontroller or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface for transmitting and receiving data to and from another apparatus. The computer C may further include an input/output interface for connecting the computer C to an input/output apparatus(es) such as a keyboard, a mouse, a display, and/or a printer.

The program P can also be stored in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can also be transmitted via a transmission medium. The transmission medium may be, for example, a communication network, a broadcast wave, or the like. The computer C can acquire the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can also be described as below. Note, however, that the present invention is not limited to the following example aspects.

### (Supplementary Note 1)

An information processing apparatus including:
an acquisition means that acquires an instance expressed as a set of a plurality of features;
a prediction means that outputs a plurality of prediction results which are obtained by using (i) as a target variable, at least one of the plurality of features which are included in the instance and (ii) as explanatory variables, a plurality of subsets of features obtained by excluding the at least one feature from the plurality of features, the subsets being different from each other; and
an abnormality degree output means that outputs a degree of abnormality of the instance, with reference to the plurality of prediction results.

### (Supplementary Note 2)

The information processing apparatus according to supplementary note 1, wherein
the prediction means outputs the plurality of prediction results by using one or more respective prediction models or prediction rules for the subsets.

### (Supplementary Note 3)

The information processing apparatus according to supplementary note 1 or 2, wherein:
relevance is given in advance between the plurality of features; and
each of the subsets is configured by the features that each have a relatively low degree of relevance with respect to the at least one feature.

### (Supplementary Note 4)

The information processing apparatus according to supplementary note 3, wherein:
the acquisition means further acquires information pertaining to the relevance; and
the prediction means identifies, with reference to the information pertaining to the relevance, the features that each have a relatively low degree of relevance with respect to the at least one feature, and configures the subset by the features identified.

### (Supplementary Note 5)

The information processing apparatus according to supplementary note 2, wherein:
the prediction means randomly makes selection of one or more features from the features obtained by excluding the at least one feature; and
the prediction means outputs the plurality of prediction results by using, as the explanatory variables, each of the subsets obtained by repeating the selection.

### (Supplementary Note 6)

The information processing apparatus according to supplementary note 2, wherein:
the prediction means includes a rule extraction means that extracts rules from respective nodes of a decision tree trained with reference to the features obtained by excluding the at least one feature from the plurality of features; and
the prediction means outputs the plurality of prediction results by using each of the rules extracted.

### (Supplementary Note 7)

The information processing apparatus according to supplementary note 6, wherein:
the rule extraction means selects a plurality of rules for outputting the prediction results, by excluding a redundant rule from the rules extracted from the respective nodes of the decision tree and narrowing the rules to a smaller number of rules.

### (Supplementary Note 8)

The information processing apparatus according to any one of supplementary notes 1 to 7, wherein:
the abnormality degree output means includes a probability calculation means that calculates a plurality of probability values each indicating likelihood of a true value that is a value of the at least one feature which corresponds to the target variable and which is included in the instance, by comparing the true value with the prediction results; and
the abnormality output means calculates the degree of abnormality by computation using the plurality of probability values respectively corresponding to the plurality of prediction results.

### (Supplementary Note 9)

The information processing apparatus according to supplementary note 8, wherein the degree of abnormality is calculated by computation using m probability values (where m is a natural number) taken in the ascending order from a smallest value from among the probability values.

### (Supplementary Note 10)

The information processing apparatus according to supplementary note 8, wherein
the degree of abnormality is calculated by computation using the probability values and a weighting factor that weights the probability values such that when the number of the explanatory variables used for obtaining the prediction results corresponding to the probability values is larger, the probability values are less weighted.

### (Supplementary Note 11)

An information processing method including:
acquiring an instance expressed as a set of a plurality of features;
outputting a plurality of prediction results which are obtained by using (i) as a target variable, at least one of the plurality of features which are included in the instance and (ii) as explanatory variables, a plurality of subsets of features obtained by excluding the at least one feature from the plurality of features, the subsets being different from each other; and
outputting a degree of abnormality of the instance, with reference to the plurality of prediction results.

### (Supplementary Note 12)

A program for causing a computer to function as an information processing apparatus that includes:
an acquisition means that acquires an instance expressed as a set of a plurality of features;
a prediction means that outputs a plurality of prediction results which are obtained by using (i) as a target variable, at least one of the plurality of features which are included in the instance and (ii) as explanatory variables, a plurality of subsets of features obtained by excluding the at least one feature from the plurality of features, the subsets being different from each other; and
an abnormality degree output means that outputs a degree of abnormality of the instance, with reference to the plurality of prediction results.

### [Additional Remark 3]

Some of or all of the foregoing example embodiments can further be expressed as below.

An information processing apparatus according an aspect of the present invention includes at least one processor, the processor carrying out:
an acquisition process for acquiring an instance expressed as a set of a plurality of features;
a prediction process for outputting a plurality of prediction results which are obtained by using (i) as a target variable, at least one of the plurality of features which are included in the instance and (ii) as explanatory variables, a plurality of subsets of features obtained by excluding the at least one feature from the plurality of features, the subsets being different from each other; and
an abnormality degree output process for outputting a degree of abnormality of the instance, with reference to the plurality of prediction results.

Note that this information processing apparatus can further include a memory, and in this memory, a program for causing the processor to carry out the acquisition process and the output column generation process can be stored. In addition, the program may be stored in a computer-readable non-transitory tangible storage medium.

### REFERENCE SIGNS LIST

10 abnormality determination apparatus
10 abnormality determination/learning apparatus
20 information processing apparatus
20A information processing apparatus
21 acquisition unit
22 prediction unit
23 abnormality degree output unit
24 training data acquisition unit
learning unit
storage unit
41 communication unit
42 input unit
43 output unit
81 rule extraction unit
101 probability calculation unit

What is claimed is:

1. An information processing apparatus comprising at least one processor, the at least one processor carrying out:
an acquisition process that acquires an instance expressed as a set of a plurality of features;
a prediction process that outputs a plurality of prediction results which are obtained by using (i) as a target variable, at least one of the plurality of features which are included in the instance and (ii) as explanatory variables, a plurality of subsets of features obtained by excluding the at least one feature from the plurality of features, the subsets being different from each other; and
an abnormality degree output process that outputs a degree of abnormality of the instance, with reference to the plurality of prediction results.

2. The information processing apparatus according to claim 1, wherein
the prediction process outputs the plurality of prediction results by using one or more respective prediction models or prediction rules for the subsets.

3. The information processing apparatus according to claim 1, wherein:
relevance is given in advance between the plurality of features; and
each of the subsets is configured by the features that each have a relatively low degree of relevance with respect to the at least one feature.

4. The information processing apparatus according to claim 3, wherein:
the acquisition process further acquires information pertaining to the relevance; and
the prediction process identifies, with reference to the information pertaining to the relevance, the features that each have a relatively low degree of relevance with respect to the at least one feature, and configures the subset by the features identified.

5. The information processing apparatus according to claim 2, wherein:
the prediction process randomly makes selection of one or more features from the features obtained by excluding the at least one feature; and
the prediction process outputs the plurality of prediction results by using, as the explanatory variables, each of the subsets obtained by repeating the selection.

6. The information processing apparatus according to claim 2, wherein:
the prediction process includes a rule extraction process that extracts rules from respective nodes of a decision tree trained with reference to the features obtained by excluding the at least one feature from the plurality of features; and
the prediction process outputs the plurality of prediction results by using each of the rules extracted.

7. The information processing apparatus according to claim 6, wherein
the rule extraction process selects a plurality of rules for outputting the prediction results, by excluding a redundant rule from the rules extracted from the respective nodes of the decision tree and narrowing the rules to a smaller number of rules.

8. The information processing apparatus according to claim 1, wherein:
the abnormality degree output process includes a probability calculation process that calculates a plurality of probability values each indicating likelihood of a true value that is a value of the at least one feature which corresponds to the target variable and which is included in the instance, by comparing the true value with the prediction results; and
the abnormality output process calculates the degree of abnormality by computation using the plurality of probability values respectively corresponding to the plurality of prediction results.

9. The information processing apparatus according to claim 8, wherein
the degree of abnormality is calculated by computation using m probability values (where m is a natural number) taken in the ascending order from a smallest value from among the probability values.

10. The information processing apparatus according to claim 8, wherein
the degree of abnormality is calculated by computation using the probability values and a weighting factor that weights the probability values such that when the number of the explanatory variables used for obtaining the prediction results corresponding to the probability values is larger, the probability values are less weighted.

11. An information processing method comprising:
acquiring an instance expressed as a set of a plurality of features;
outputting a plurality of prediction results which are obtained by using (i) as a target variable, at least one of the plurality of features which are included in the instance and (ii) as explanatory variables, a plurality of subsets of features obtained by excluding the at least one feature from the plurality of features, the subsets being different from each other; and
outputting a degree of abnormality of the instance, with reference to the plurality of prediction results.

12. A non-transitory storage medium having a program stored therein, the program for causing a computer to function as an information processing apparatus, the program causing the computer to carry out:
an acquisition process that acquires an instance expressed as a set of a plurality of features;
a prediction process that outputs a plurality of prediction results which are obtained by using (i) as a target variable, at least one of the plurality of features which are included in the instance and (ii) as explanatory variables, a plurality of subsets of features obtained by excluding the at least one feature from the plurality of features, the subsets being different from each other; and
an abnormality degree output process that outputs a degree of abnormality of the instance, with reference to the plurality of prediction results.
